(19) United States
(12) Patent Application Publication
(10) Pub. No.: US 2018/0158115 A1
(43) Pub. Date: Jun. 7, 2018

(54) E-COMMERCE CONTRACTOR PRICE QUOTING SYSTEM AND METHOD

(71) Applicants: Xiaofan Wu, Valencia, CA (US); Gary Zhewei Wu, Valencia, CA (US); Katelynn Yanran Wu, Valencia, CA (US)

(72) Inventors: Xiaofan Wu, Valencia, CA (US); Gary Zhewei Wu, Valencia, CA (US); Katelynn Yanran Wu, Valencia, CA (US)

(21) Appl. No.: 15/367,120

(22) Filed: Dec. 1, 2016

(51) Int. Cl. G06Q 30/02; H04W 4/02; G06Q 30/06

(52) U.S. Cl. CPC G06Q 30/0283; G06F 3/0482; G06Q 30/0601; H04W 4/02

(57) ABSTRACT

An improved interactive e-commerce system for a mobile phone or computer of a user that modifies at least one of labor and materials prices through a combination price quote (CPQ) request from at least one of one or more service providers and one or more goods providers. In this system, a CPQ module icon on the screen display is configured to connect to a CPQ module. The CPQ module selectively interacts with and modifies functionality of at least one electronic processing unit responsible for functionality of at least one of a screen display module, a location tracking module, and a central processing unit module to select and display only a selected number of one or more combination price quote (CPQ) selections on the mobile device based on responses by user to a pre-formulated questionnaire. Upon activation of the CPQ module icon, the CPQ module communicates to a portion of the selected number of the one or more combination price quote selections selected by a CPQ selection management module responsive to a selection by the user. The user includes a consumer, a service provider, and a goods provider.

### COPYRIGHT NOTICE

This disclosure contains material which is subject to copyright protection. The copyright owner makes no objection to reproduction of this disclosure as disclosed in the Patent and Trademark Office files, record, or the like. Otherwise, the copyright owner reserves all copyright rights whatsoever for this patent disclosure. 37 CFR 1.71(d).

### BACKGROUND OF THE DISCLOSURE

The following information may be useful in a better understanding of this disclosure. Please note that information contained in this section is not an admission that the information provided is material or prior art to this disclosure or as described in claimed disclosure, or that any publication or document that is specifically, implicitly or otherwise referenced is prior art.

### 1. Field of the Disclosure

The inventive device disclosed in the present application generally relates to mobile telephone and computer applications including software programs or applications for a cellular phone or mobile phone, or computer and more specifically, a user-friendly, automatic price quoting application which allows the user interactively generate and receive labor and materials bids more accurately from a contractor or service provider on a user mobile device or a computer.

### 2. Description of the Related Art

When a consumer seeks to obtain a price estimate to replace floor coverings in his home, the consumer can easily calculate a rough estimate of the basic costs by adding the cost of goods (multiplying the square footage of the flooring area by the square footage price of the specific tile desired) to the cost of labor (multiplying the square footage of the flooring area by a contractor's stated price of labor per square foot). This, however, is only a rough estimate because it fails to include any hidden costs that ordinarily would occur.

In addition, a skilled and/or experienced contractor is able to provide a more accurate estimate by personally visiting the work site to determine the hidden costs that are due to circumstantial factors such as 1) type of subfloor, 2) How much demolition is needed, 3) how much accessory material such as adhesives, nails, base boards, plywood, are needed, and 4) if the work site includes any corners, stairs, or other irregular dimensions.

As such, calculating an accurate initial price quote, however, requires time and experience. For example, an experienced contractor would have to schedule an appointment to meet the consumer, travel to the work site, take measurements, and visually inspect the work site. And once the experienced contractor has visually inspected the work site and has taken measurements, the contractor would have to be sufficiently experienced to notice circumstantial factors that may contribute to hidden costs. Therefore, a contractor who is successful in generating leads from his or her advertisements are often challenged with the task of converting these leads to actual contracts by having to send experienced staff all around town so an accurate initial price quote can be given under time constrain.

In addition, it would be great if contractors would quickly and accurately provide a price quote on service contracts where hidden costs are difficult to calculate. Contractors, especially those that have an online presence, are often bombarded by consumer inquiries for price estimates over the Internet or over the phone. If overestimates, the contract may lose a potential contract. If underestimates, the contractor may gain the contract, but subsequently loses profit margin and/or credibility with the consumer when hidden costs are unexpectedly included in the final invoice.

Currently known software assisting a contractor estimate the total cost of a contractual work requires the contractor to enter every little detail in order to receive an accurate estimate. The contractor stills has to visually inspect the work site and be sufficiently experienced to determine how much added material and labor is needed based on circumstantial factors.

Therefore, there is a need for an automated process to provide accurate initial price quotes to replace contractor's estimate where the price quote includes basic costs and hidden costs.

Further, there remains to be a need for an automated process to provide a price quote that includes basic costs and hidden costs in any service industry where hidden cost is a factor in providing accurate price quotes.

Within this disclosure, please note that all referenced patents, applications and literatures are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The embodiment may seek to satisfy one or more of the above-mentioned desires. Although the below disclosed embodiments may obviate one or more of the above-mentioned desires, it should be understood that some aspects of the embodiments might not necessarily obviate them.

### BRIEF SUMMARY OF THE DISCLOSURE

In view of the foregoing disadvantages inherent in the known mobile device or computer application art, the present disclosure provides novel price quoting and on-line platform mobile device or computer application for a user, e.g., a consumer, a service provider, a goods provider, or the like, to receive a desired quote for services and/or assist others with receiving desired quote for requests for goods and/or services.

The general purpose of the present disclosure, which will be described subsequently in greater detail, is to provide a user-friendly application, which allows user (e.g., consumer, service provider, good provider, or the like) of mobile device, desktop, and laptop computer to request a combination price quote (CPQ) for any conceivable service work, e.g., construction works, home repairs, home renovations, painting, catering, babysitting, and the like. Advantageously, this present disclosure allows a user interactively, for example, be guided through selection from a portion of a number of combination price quote selections and request by user additional quotes/services from this portion. As such, the user-friendly application obtains a consumer desired combination price for any conceivable service work, and this application can be installed on any mobile device, desktop, laptop computers and alike. Furthermore, the user-friendly application of the present disclosure is relatively inexpensive to build and set up, which makes it attractive to both business as well as personal user.

An improved interactive e-commerce system is disclosed for a mobile phone, or a computer of a user that modify: at least one of labor and materials prices through a combination price quote (CPQ) request from at least one of one or more service providers and one or more goods providers. In this system, a CPQ module icon on the screen display is configured to connect to a CPQ module. The CPQ module selectively interacts with and modifies functionality of at least one electronic processing unit responsible for functionality of at least one of a screen display module, a location tracking module, and a central processing unit module to select and display only a selected number of one or more combination price quote (CPQ) selections on the mobile device or computer based on responses by the user to a pre-formulated questionnaire. Upon activation of the CPQ module icon, the CPQ module communicates to a portion of the selected number of the one or more combination price quote selections selected by a CPQ selection management module responsive to a selection by the user. For example, the user includes a consumer, a service provider, and a goods provider.

A method of improved interactive e-commerce system is disclosed for a mobile phone or computer of a user that modifies at least one of labor and materials prices through a combination price quote (CPQ) request from at least one of one or more service providers and one or more goods providers. In this method, the steps include: activate a CPQ module icon on the screen display; selectively interact by a CPQ module with and modify functionally of at least one electronic processing unit responsible for functionality of at least one of a screen display module, a location tracking module, and a central processing unit module to select and display only a selected number of one or more combination price quote (CPQ) selections on the mobile device based on responses by user to a pre-formulated questionnaire; and communicate utilizing the CPQ module by pressing the CPQ module icon on the screen display a portion of the selected number of the one or more combination price quote selections selected by a CPQ selection management module responsive to a selection by the user. For example, the user includes a consumer, a service provider, and a goods provider.

The present disclosure holds significant improvements and serves as e-commerce composite price quote for goods and/or services system and method. As described herein, it is to be understood that not necessarily advantages, and novel features may be achieved in accordance with any one particular embodiment of the disclosure. Thus, the disclosure can be embodied or carried out in a manner that optimizes or achieves one or a group thereof of advantages as taught herein without achieving many or all advantages as may be taught or suggested. Features of the disclosure which are believed to be novel are distinctly claimed in the specification. It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

### BRIEF DESCRIPTION OF THE DRAWINGS

The figures which accompany the written portion of this specification illustrate embodiments and method(s) of use for the present disclosure, combination price quoting (CPQ) mobile device system, e.g., CPQ module icon and system 101, 100, constructed and operative according to the teachings of the present disclosure.

FIG. 1 shows a functional system diagram illustrating CPQ module icon and system 101, 100 according to an embodiment of the present disclosure.

FIG. 2 illustrates a block diagram 200 of processing system 200 illustrating interaction between CPQ module icon and system 101, 100 and mobile device 106 according to an embodiment of the present disclosure of FIG. 1.

FIG. 3 is a block diagram 300 that illustrates profiles of users of the CPQ module icon and system 101, 100 downloaded on mobile device (mobile phone) 106 according to an embodiment of the present disclosure of FIG. 1.

FIG. 4 is a block diagram 400 that illustrates calculations of basic costs 117, cost of goods 141, cost of labor 143, and hidden costs 119 and generates a price quote 145 of the CPQ module icon and system 101, 100 downloaded on mobile device (mobile phone) 106 according to an embodiment of the present disclosure of FIG. 1.

FIG. 5 is a screen shot 500 of a pre-formulated questionnaire 115 that illustrates CPQ module icon and system 101, 100 downloaded on mobile device (mobile phone) 106 according to an embodiment of the present disclosure of FIG. 1.

FIG. 6 is a screen shot 600 of a pre-formulated questionnaire 115 that illustrates CPQ module icon and system 101, 100 downloaded on mobile device (mobile phone) 106 according to an embodiment of the present disclosure of FIG. 1.

FIG. 7 is a screen shot 700 of a Composite Price Quote (CPQ) for Contractor 1 including basic cost 117 and hidden cost 119 that illustrates CPQ module icon and system 101, 100 downloaded on mobile device (mobile phone) 106 according to an embodiment of the present disclosure of FIG. 1.

FIG. 8 is a screen shot 800 of type of labor rates and threshold perimeter 151 determining if a first labor rate or a second labor rate applies that illustrates CPQ module icon and system 101, 100 downloaded on mobile device (mobile phone) 106 according to an embodiment of the present disclosure of FIG. 1.

FIG. 9 is a screen shot 900 of hidden cost multipliers 121, 123, 125, 127, 129 based on first or second circumstantial condition 147 being present that illustrates CPQ module icon and system 101, 100 downloaded on mobile device (mobile phone) 106 according to an embodiment of the present disclosure of FIG. 1.

FIG. 10 is a screen shot 1000 of numerical perimeter 149 and threshold perimeter 151 that illustrates CPQ module icon and system 101, 100 downloaded on mobile device (mobile phone) 106 according to an embodiment of the present disclosure of FIG. 1.

FIG. 11 is a screen shot 1100 of the CPQ selections 118 that illustrates CPQ module icon and system 101, 100 downloaded on mobile device (mobile phone) 106 according to an embodiment of the present disclosure of FIG. 1.

FIG. 12 is a flowchart 1200 illustrating a method of use for CPQ module icon and system 101, 100 according to an embodiment of the present disclosure of FIGS. 1-11.

The various embodiments of the present disclosure will hereinafter be described in conjunction with the appended drawings, wherein like designations denote like elements.

### DETAILED DESCRIPTION

As discussed above, embodiments of the present disclosure application generally relates to software programs for mobile or desktop telecommunication apparatus such as a cellular phone or computer, and more specifically to more specifically to user-friendly, automatic price quoting application which allows the user interactively generate and receive labor and materials bids more accurately from one or more contractors, service providers, and goods providers on a user mobile device or computer.

Embodiments of the present disclosure relate to a downloadable phone app comprising a toggle switch device and more particularly to CPQ module icon and system, e.g., a touch screen toggle switch for use on cellular smartphones and tablet computers to provide consumers a screen display and/or screen menu on these electronic devices. CPQ icon and system can install CPQ module icon and module onto user mobile or desktop device.

Reference is now made to the drawings wherein like numerals refer to like parts throughout.

As used herein, the term “wireless” refers to wireless communication to a device or between multiple devices. Wireless devices may be anchored to a location and/or hardwired to a power system, depending on the needs of the business, venue, event or museum. In one embodiment, wireless devices may be enabled to connect to Internet, but do not need to transfer data to and from Internet in order to communicate within the wireless information communication and delivery system.

As used herein, the term “Smart Phone” or “smart phone” or “mobile device(s)” or “cellular phone” or “cellular” or “mobile phone” or the like refers to a wireless communication device, that includes, but not is limited to, an integrated circuit (IC), chip set, chip, system-on-a-chip including low noise amplifier, power amplifier, Application Specific Integrated Circuit (ASIC), digital integrated circuits, a transceiver, receiver, or transmitter, dynamic, static or non-transitory memory device(s), one or more computer processor(s) to process received and transmitted signals, for example, to and from the Internet, other wireless devices, and to provide communication within the wireless information communication and delivery system including send, broadcast, and receive information, signal data, location data, a bus line, an antenna to transmit and receive signals, and power supply such as a rechargeable battery or power storage unit. The chip or IC may be constructed (“fabricated”) on a “die” cut from, for example, a Silicon, Sapphire, Indium Phosphide, or Gallium Arsenide wafer. The IC may be, for example, analogue or digital on a chip or hybrid combination thereof. Furthermore, digital integrated circuits may contain anything from one to thousands or millions of signal inverters, and logic gates, e.g., “and”, “or”, “nand” and “nor gates”, flipflops, multiplexors, etc., on a square area that occupies only a few millimeters. The small size of, for instance, IC's allows these circuits to provide high speed operation, low power dissipation, and reduced manufacturing cost compared with more complicated board-level integration.

As used herein, the terms “wireless”, “wireless data transfer,” “wireless tracking and location system,” “positioning system” and “wireless positioning system” refer without limitation to any wireless system that transfers data or communicates or broadcasts a message, which communication may include location coordinates or other information using one or more devices, e.g., wireless communication devices.

As used herein, the terms “module” or “modules” refer without limitation to any software, software program(s), firmware, or actual hardware or combination thereof that has been added on, downloaded, updated, transferred or originally part of a larger computation or transceiver system that assists in or provides computational ability including, but not limited to, logic functionality to assist in or provide communication broadcasts of commands or messages, which communication may include location coordinates or communications between, among, or to one or more devices, e.g., wireless communication devices.

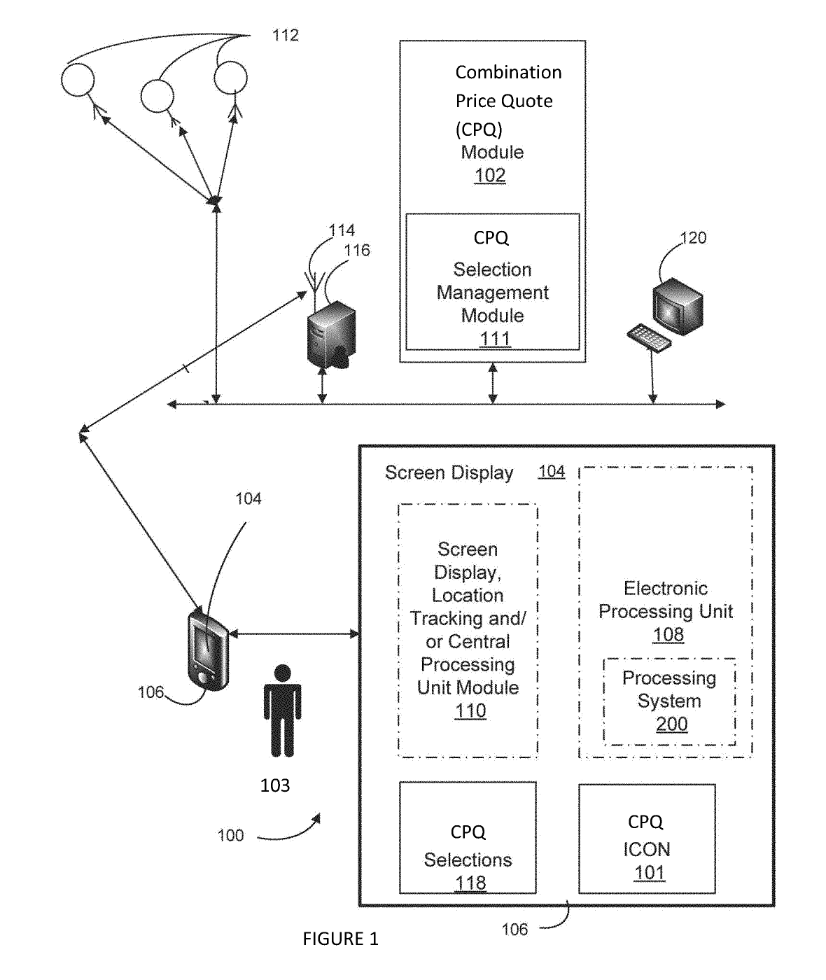

FIG. 1 shows a functional system diagram illustrating CPQ module icon 101 and System 100 according to an embodiment of the present disclosure.

Referring to the drawings by numerals of reference there is shown in FIG. 1, system 100 is an improved interactive e-commerce system for a mobile phone or computer of a user 103 that modifies at least one of labor and materials prices through a combination price quote (CPQ) request from at least one of one or more service providers and one or more goods providers. For example, the user 103 includes any or all the following: a consumer, a service provider, and a goods provider.

In system 100 a CPQ module icon 101 on the screen display 104 is configured to connect to a CPQ module 102. The CPQ module 102 selectively interacts with and modifies functionality of at least one electronic processing unit 108 responsible for functionality of one or more of a screen display module, a location tracking module, and a central processing unit module 110 to select and display only a selected number of one or more composite price quote (CPQ) selections 118 on the mobile device or computer 106 based on responses by user to a pre-formulated questionnaire 105.

For example, the screen display module, the location tracking module, and/or the central processing unit 110 work together to select and display one or more price quote (CPQ) selections based on any or all the following: i.) central processing unit module 110 performs comparisons and price quotes; ii.) location (location tracking module 110 assists providing proximity analysis for location of goods and services providers); and iii.) screen display module 110 selectively displays based on central processing unit module 110, CPQ module 102, and location tracking module 110 composite results, e.g., of the one or more composite price quote (CPQ) selections 118 to the user 103.

Upon activation of the CPQ module icon 101, the CPQ module 102 communicates a portion of the selected number of the one or more combination price quote (CPQ) selections 118 selected by a CPQ selection management module 111 responsive to a selection by the user 103.

In some embodiments, the responses by the user 103 include a plurality of answers 113 to the pre-formulated questionnaire 115 regarding the request through the CPQ module 102 to the at least one of the one or more service providers and the one or more goods providers; and responsive to the plurality of answers 113, the at least one of the one or more service providers and the one or more goods providers provide at least one of a labor rate (e.g., unit price of labor 131) and a hidden cost multiplier (e.g., multiplier(s) 121, 123, 125, 127, and 129).

In some embodiments, the user communicates through the CPQ module 102 a plurality of answers 113 from the user 103 responsive to the pre-formulated questionnaire 115 and responsive to the plurality of answers 113, the CPQ module 102 calculates a basic cost 117 and a hidden cost(s) 119 respectively responsive to the plurality of answers and a labor rate (e.g., unit price of labor 131) and a hidden cost multiplier (e.g., multiplier(s) 121, 123, 125, 127, and 129) provided by the at least one of the one or more service providers and the one or more group providers responsive to the plurality of answers 115. In one example, the user 103 accepts one of the selected number of the one or more combination price quote (CPQ) selections 118.

Advantageously, using system 100, user can be a goods provider or a services provider who is shopping for a CPQ for the customer based on a consumer profile, e.g., expected features, expected costs, expected completion date, or the like. As such, system 100 advantageously provides for real-time feedback between goods provider and service provider responsive to a consumer profile, e.g., needs or desired.

In some embodiments, a pre-formulated questionnaire 115 is supplied for a user 103 who is looking to replace floor coverings. For example, the pre-formulated questionnaire 115 includes questions, for example:

For each of your flooring area 133, 137 (e.g., the living room, the basement, master bedroom, and hallway) that requires new floor covering, what is the type of your existing floor covering? (Select an answer 113 from a pull-down menu for each flooring area 133, 137.)

For each of your flooring area 133, 137 (e.g., the living room, the basement, master bedroom, and hallway) that requires new floor covering, do you need demolition of your existing floor covering? (Select an answer 113 from a pull-down menu for each flooring area 133, 137.)

For each of your flooring area 133, 137 (e.g., the living room, the basement, master bedroom, and hallway) that requires new floor covering, what is your existing subfloor type? (Select an answer from a pull-down menu for each flooring area.)

For each of your flooring area 133, 137 (e.g., the living room, the basement, master bedroom, and hallway) that requires new floor covering, what is the type of new floor covering you are asking a price quote for 141? (Select all that applies for each flooring area 133, 137, from a myriad of tile styles, materials, colors, and carpet types, colors, thickness, padding types, thickness, etc.)

What is the area for each of your flooring area 133, 137 (e.g., the living room, the basement, master bedroom, and hallway) that requires new floor covering? (Enter a numerical value for each flooring area 133, 137.)

For each of your flooring area 133, 137 (e.g., the living room, the basement, master bedroom, and hallway) that requires new floor covering, does it include stairs or steps? (Select an answer from a pull-down menu for each flooring area 133, 137.)

In some embodiments, using system 100, when the user hits enter, the system 100 calculates the “basic costs 117” (cost of goods 141 and cost of labor 143) using previously-saved data on a database 120. These previously-collected data 120 can be any one or more of the following:

Default data 120 (e.g., commonly accepted labor cost per square foot in a geographical area to install marble tiles provided by the administrator of the system,

Custom data 120 provided by the service provider (e.g., the service provider's own labor cost 143 per square foot to install marble tile, the service provider's marked-up price on a particular brand of marble tile), and

Manufacturer's data 120 provided by the manufacturer of the goods (e.g., XYZ Tile Company's stated price on a particular style of marble tile.)

In some embodiments, in addition to the basic costs 117, the system 100 calculates “added costs”, e.g., hidden costs 119, that are due to circumstantial factor 147 gathered in the pre-formulated questionnaire 115. For example, in a situation where existing vinyl floor covering must be removed, and the plywood subfloor must be prepped, and the flooring area 133, 137 includes a short flight of stairs of three steps, the system's calculation would result in an added cost that includes: additional parts (marble tiles, adhesives, nails, retaining brackets, baseboards, etc.) and additional labor hours.

In some embodiments, the system 100 would apply a multiplier 121, 123, 125, 127, 129 (for example, 0.0213), as part of its CPQ algorithm 102, 111, in cases like this one, and the resulting number would be close to the cost of parts and labor of about 178 feet of baseboard of the same marble tile, about 13 tubes of tile adhesives, and about 14 retaining brackets.

As such, this estimate more fairly estimate and accurately reflect an actual cost for completion.

In some embodiments, the system 100 allows a consumer to see previous consumer review and rating data for each contractor, and allows a consumer to see the percentage difference between previously quoted prices vs. actual final cost for each specific contractor.

In some embodiments, advantageously, this system 100 is open for contractors across the country for registration (for free or for a fee). In this way, a consumer can use the platform to search and receive price estimates from all contractors who are registered with the platform.

Optionally, the consumer, e.g., as a user, may choose to receive price estimates only from contractors that are located within a certain mile, e.g., 25 mile, radius from the work site. In this way, a consumer can quickly receive accurate price estimates from a large group of contractors. For example, a consumer enters multiple choices in any or all categories of answers 113 to produce a comprehensive search result having different permutations based on additional options. The following are examples:

| Questions on the | The Consumer Picked |
|---|---|
| Questionnaire | Multiple Answers |
| Type of space | Living Room |
| being renovated | Bedroom 1 (1020 ft2) |
| | Bedroom 2 (400 ft2) |
| | Entry way (1250 ft2) |
| | with a circular staircase |
| Type of new | Brand X marble tile model X-1214 |
| flooring | Brand Y travatine tile model Y-4556 |
| to be installed | Brand Y Aspen Berber model |
| | E-232 color blue |
| Type padding | Scotchguard ™ brand ½ inch thick |
| for carpet | foam padding |
| | Memory foam with Dupont ® |
| | Teflon protector |
| | 8 lb. Trafficmaster ™ brand padding |

Based on the above entries, the consumer receives a comprehensive search result that allows the consumer to see the cost of various flooring options for each area (living room, room 1, room 2, and lobby) of his home from hundreds of contractors. As such, consumer sorts through and visualized the composite price quote combination. Also, system 100 allows user to narrow the search results to contractors having historic estimate vs. final price percentage discrepancy of no more than a certain percentage; e.g., 5%. In yet another embodiment, the user 103 sees an overall “at-a-glance” list of price estimates for all options for all areas of his house. In this way, the user can now easily and quickly pick and chose an option for each area and watch the total estimate change. After a few tries, the user 103 determines the most optimal flooring option for each area based on personal preference (e.g., now knowing options, perhaps user upgrades his first floor entry and downgrade his bedroom 2) yet still stay within budget.

In still another embodiment, the platform can be synched to a third party website for their contents. One example is synching “reviews” from www.yelp.com.

In still another embodiment, user 103, e.g., service provider, contractor, consumer or the like, may choose a service/product provider upon multiple criteria, e.g., the price being one of many facts.

In one example of this embodiment, user 103 may consider to choose a provider, e.g., contractor, service provider, or the like upon the following selector or sorter, for example, in accordance with any or all the following:

a.) the consumer reviews,

b.) distance between the consumer and provider, and

c.) relevance between consumer search terms and service provider offered term.

For example, in this application, a relevance list sorts a relevance of consumer search and services provided. In specific example, if a user 103 searches for “wood floor”, the search providers that offers “wood floor” will rank higher on the relevance list and the providers that offer “laminate floor” and/or “carpet floor” will rank lower.

In some embodiments, for the previous quoted price and actual price differentiation, a user 103 searches through previous customer reviews and rating data for each provider.

In some embodiment, a complexity of CPQ module 102 varies. For example, some providers offer very detailed CPQ module 102, while still others offer very simplified CPQ module 102. In one example, the consumers choose from a list of complicated or simplified CPQ modules 102 first before entering selections per their individual needs.

Now regarding contractor registration, in some embodiments, a contractor sets up an account to accept default prices set by the administrator. Alternatively, the contractor enters own values:

| | When | When the job | When |
|---|---|---|---|
| | the job | is between | the job |
| The contractor may enter a | is under | threshold and | is over |
| value for the following fields | threshold | 1500 sq. ft. | 1501 sq. ft. |
| My labor cost to install marble | Minimum | $10 | $6 |
| tiles per sq. ft. | charge | | |
| My labor cost to install nylon | | $2 | $1 |
| sheets per sq. ft. | | | |
| My labor cost to install carpet | | $4 | $3 |
| per sq. ft. | | | |
| My labor cost to remove old | | $1 | $0.5 |
| carpet per sq. ft. | | | |
| My labor cost to remove old tile | | $3 | $1.5 |
| floor per sq. ft. | | | |
| My labor cost to install sheet | | $4 | $3 |
| rock per sq. ft. | | | |
| I am willing to give discounted | | $6 | $4 |
| pricing when the work site is | | | |
| within how many miles from | | | |
| me. | | | |

Each contractor can pick and choose which products they offer and their perspective prices. They may also pick manufacturer's listed price or enter their own price for each specific price on the products they offer.

In some embodiments, the platform and its support system provides for a contractor or a product manufacturer/supplier to upload a large list of products and prices at once.

In some embodiments, the pre-formulated questionnaire 115 communicates responses including a plurality of answers 113 thereto regarding the CPQ request from the CPQ module 102 to the at least one of the one or more service providers and the one or more group providers; wherein the CPQ module 102 calculates a basic cost 117 and a hidden cost 119 respectively responsive to the plurality of answers 113 and a basic labor cost 143 and a hidden cost multiplier 121, 123, 125, 127, 129 provided by the at least one of the one or more service providers and the one or more group providers responsive to the plurality of answers 113; and wherein the user 103 accepts one of the selected number of the one or more combination price quote (CPQ) selections 118.

In some embodiments, the CPQ module 102 selectively interacts with and modifies functionality of at least one electronic processing unit 108 responsible for functionality of a screen display module, a location tracking module, and a central processing unit module 110 on the mobile device 106 includes the CPQ module 102 modifying central and auxiliary processing unit instruction sets for the CPQ selection management module 111 on the screen display of the mobile device 106 responsive with the selection by the user.

In some embodiments, the pre-formulated questionnaire 115 includes questions that ask for a numerical perimeter 149, a first question of the questions asks whether a first circumstantial condition 147 is present, and a second question of the questions asks whether a second circumstantial condition 147 is present. In one example, the hidden cost multiplier 121, 123, 125, 127, 129 includes a first cost multiplier 121, 123, 125, 127, 129 and a second hidden cost multiplier 121, 123, 125, 127, 129. In one example, the first hidden cost multiplier 121, 123, 125, 127, 129 is assigned to the first circumstantial condition 147, and a second hidden cost multiplier 121, 123, 125, 127, 129 is assigned to the second circumstantial condition 147.

In some embodiments, the labor rate 131 includes a first labor rate and a second labor rate. In one example, the at least one of the one or more service providers and the one or more goods providers enters the second labor rate and a threshold perimeter 151. In one example, the basic cost 117 is a function of the first labor rate when the numerical perimeter 149 is below the threshold perimeter 151. In another example, the basic cost 117 is a function of the second labor rate when the numerical perimeter 149 is equal to or above the threshold perimeter 151.

In some embodiments, the system is an online platform, an online social network, a software, or a mobile device application, e.g., mobile, desktop, laptop or alike application; wherein the one or more goods providers include manufacturers of goods, distributors of goods, retailers of goods, even home-made stores; and wherein the one or more service providers include any one who provides services whether or not the service is related to a particular goods.

In some embodiments, the CPQ selection management module 111 can be modified in accordance with instructions and electronic drivers and programming from the CPQ module 102. In one example, the at least one electronic processing unit includes at least one of a central processing unit, a device driver, a display driver, an electronic driver, a module or application driver, and a screen display driver. In one example, the CPQ selection management module 111 includes a screen menu, the screen menu provides for the user moving one or more fingers up, down, side to side and around the screen menu to select one of the one or more CPQ selections 118.

In some embodiments, the one or more CPQ selections 118 include: names of the at least one of the one or more service providers and the one or more goods providers, the labor rate of a selection of quotes of the one or more service providers, the hidden cost multiplier of a selection of bides of at least one of the one or more service providers and the one or more goods providers, and a possible price for the request each of quote of at least one of the one or more service providers and the one or more goods providers.

In some embodiments, the one or more CPQ selections 118 include videos or sound tracks that include advertisements and company specific information responsive to the one or more CPQ selections 118 to the user; wherein the one or more videos or sound tracks are communicated wireless 114, 116, 120 with a satellite communication or satellite link 112 to the user on the mobile device 106. In some embodiments, the one or more CPQ selections 118 are configured to provide sound tracks including itemized information pertaining to basic labor costs 117, hidden cost multipliers 121, 123, 125, 127, 129, sales information and other pertinent data relevant to the request selected for the user on the mobile device 106.

As disclosed, the present disclosure is a module or application designed to run on desktop computers, laptop computers, smart phones, tablet computers, other mobile devices. This module or application typically operated by the owner of the mobile operating system, laptop computer or desktop computer. Frequently, they are downloaded from the platform to a target device, such as an iPhone, Android, or Windows phone and downloadable to laptops or desktop computers.

Advantageously, by using the present disclosure, pressing the CPQ module icon initiating the CPQ module icon and system and based on request, phone owner, e.g., user, is provided a choice of one or more CPQ including, for example, a basic labor cost and hidden cost, and company related music, recorded message, video, company informative presentations, or the like, that will be played for person on their mobile device or computer.

Advantageously, CPQ module icon and system comprises a novel product offering consumers a practical solution to the aforementioned challenges. Furthermore, CPQ module icon and System is a specially configured software module or application for use with cellular smartphones, handheld tablet computers, laptop or desktop computer with module or application featuring a touch screen toggle switch that can be utilized when operating screen display options on one's electronic device.

Advantageously, as an easily activated touch screen toggle switch responds to the slightest touch, CPQ module icon and system enables users to effortlessly modify CPQ selections from CPQ selection management module in a down, back and forth with ease. According, this software module or application is a practical alternative to traditional off/on operational controls; CPQ module icon and system would enhance mobile device screen display features, and improving user/person mobile device experience in the home or on the go.

Advantageously, the contemplated system facilitates consumers in seeking and obtaining accurate price quotes from service providers for construction works, home repairs, home renovations, painting, caterings, babysitting, and any conceivable service work where an accurate price quote would reasonably include “basic costs” (e.g., cost of labor per unit and cost of goods per unit) and “added costs” (based on circumstantial factors). Such system can also facilitate service providers by streamlining the process of providing accurate price quotes to consumers.

Advantageously, the system 100 has a backend algorithm, e.g., users 103 include goods and services providers, to automatically generate price quotes (including basic costs and added costs) to a consumer inquiry, based on the consumer's entry a set of questionnaire 115.

Advantageously, a set of questionnaire 115 is supplied for a consumer who is looking to replace floor coverings. The questionnaire may include questions, for example:

For each of your flooring area 133, 137 (e.g., the living room, the basement, master bedroom, and hallway) that requires new floor covering, what is the type of your existing floor covering? (Select an answer from a pull-down menu for each flooring area 133, 137.)

For each of your flooring area 133, 137 (e.g., the living room, the basement, master bedroom, and hallway) that requires new floor covering, do you need demolition of your existing floor covering? (Select an answer from a pull-down menu for each flooring area 133, 137.)

For each of your flooring area 133, 137 (e.g., the living room, the basement, master bedroom, and hallway) that requires new floor covering, what is your existing subfloor type? (Select an answer from a pull-down menu for each flooring area 133, 137.)

For each of your flooring area 133, 137 (e.g., the living room, the basement, master bedroom, and hallway) that requires new floor covering, what is the type of new floor covering you are asking a price quote for? (Select all that applies for each flooring area, from a myriad of tile styles, materials, colors, and carpet types, colors, thickness, padding types, thickness, etc.)

What is the area for each of your flooring area 133, 137 (e.g., the living room, the basement, master bedroom, and hallway) that requires new floor covering? (Enter a numerical value for each flooring area 133, 137.)

For each of your flooring area 133, 137 (e.g., the living room, the basement, master bedroom, and hallway) that requires new floor covering, does it include stairs or steps? (Select an answer from a pull-down menu for each flooring area 133, 137.)

When the consumer hit enter, the system would calculate the “basic costs” 117 (cost of goods and cost of labor) using previously-saved data on a database. These previously-collected data 120 can be any one or more of the following:

Default data (e.g., commonly accepted labor cost per square foot in a geographical area to install marble tiles provided by the administrator of the system,

Custom data provided by the service provider (e.g., the service provider's own labor cost per square foot to install marble tile, the service provider's marked-up price on a particular brand of marble tile), and

Manufacturer's data provided by the manufacturer of the goods (e.g., XYZ Tile Company's stated price on a particular style of marble tile.)

In addition to the basic costs 117, the system can calculate “added costs” 119 that are due to circumstantial factor 147 gathered in the questionnaire 115. For example, in a situation where existing vinyl floor covering must be removed, and the plywood subfloor must be prepped, and the flooring area includes a short flight of stairs of three steps, the system's calculation would result in an added cost that includes: additional parts (marble tiles, silicon adhesives, nails, retaining brackets, baseboards, etc.) and additional labor hours.

In another embodiment, the algorithm would apply a multiplier 121, 123, 125, 127, 129 (for example, 0.3) in cases like this one, and the resulting number would be close to the cost of parts and labor of about 178 feet of baseboard of the same marble tile, about 13 tubes of tile silicon adhesives, and about 14 retaining brackets.

This estimate would be fairly accurate to actual cost.

Advantageously, the platform allows a consumer to see previous consumer review and rating data for each user, e.g., contractor, provider, or the like, and allows a consumer to see the percentage difference between previously quoted prices vs. actual final cost for each specific contractor.

Advantageously, this platform is open for contractors across the country for registration (for free or for a fee). In this way, a consumer can use the platform to search and receive price estimates from all contractors who are registered with the platform. Optionally, the consumer may choose to receive price estimates only from contractors that are located within a certain, e.g., 25 mile, mile radius from the work site. In this way, a consumer can quickly receive accurate price estimates from a large group of contractors. Additionally, a consumer can enter multiple choices in any or all categories of answers to produce a comprehensive search result having different permutations based on additional options. The following are examples:

| Questions on the | The Consumer |
|---|---|
| Questionnaire | Picked Multiple Answers |
| Type of space | Living Room |
| being renovated | Bedroom 1 (1020 ft2) |
| | Bedroom2 (400 ft2) |
| | Entry way (1250 ft2) with a circular staircase |
| Type of new | Brand X marble tile model X-1214 |
| flooring | Brand Y travatine tile model Y-4556 |
| to be installed | Brand Y Aspen Berber model E-232 color blue |
| Type padding | Scotchguard ™ brand ½ inch thick foam padding |
| for carpet | Memory foam with Dupont ® Teflon protector |
| | 8 lb. Trafficmaster ™ brand padding |

Based on the above entries, in some embodiments, the consumer receives a comprehensive search result that allows the consumer to see the cost of various flooring options for each area (living room, room 1, room 2, and lobby) of a consumer's home from hundreds of contractors. Consumer can also sort and see the combination price quote (CPQ). Consumer can also narrow search results to contractors having historic estimate vs. final price percentage discrepancy of no more than 5%. In yet another embodiment, the consumer can see an overall “at-a-glance” list of price estimates for all options for all areas of his house.

Advantageously, the consumer can now easily and quickly pick and chose an option for each area and watch the total estimate change. After a few tries, the consumer determines the most optimal flooring option for each area based on his personal preference (e.g., now knowing options, so as to make wiser decisions: for example, be able to upgrade first floor entry and downgrade bedroom and still stay within budget.

In still another embodiment, the platform can be synched to a third party website for their contents. One example is synching “reviews” from www.yelp.com.

In one example, regarding contractor registration, a contractor sets up account to accept default prices set by the administrator. Alternatively, the contractor, e.g., good and/or service supplier, may enter own values:

| | When | When the job | When |
|---|---|---|---|
| | the job | is between | the job |
| The contractor may enter a | is under | threshold and | is over |
| value for the following fields | threshold | 1500 sq. ft. | 1501 sq. ft. |
| My labor cost to install marble | Minimum | $10 | $6 |
| tiles per sq. ft. | charge | | |
| My labor cost to install nylon | | $2 | $1 |
| sheets per sq. ft. | | | |
| My labor cost to install carpet | | $4 | $3 |
| per sq. ft. | | | |
| My labor cost to remove old charge | | $1 | $0.5 |
| carpet per sq. ft. | | | |
| My labor cost to remove old tile | | $3 | $1.5 |
| floor per sq. ft. | | | |
| My labor cost to install sheet | | $4 | $3 |
| rock per sq. ft. | | | |
| I am willing to give discounted | | $6 | $4 |
| pricing when the work site is | | | |
| within how many miles from | | | |
| me. | | | |

Each contractor can pick and choose which products they offer and their perspective prices. They may also pick manufacturer's listed price or enter their own price for each specific price on the products they offer.

In some embodiments, the platform and its support system is provided for a contractor or a product manufacturer/supplier to upload a large list of products and prices at once.

In some embodiments, an automated price quoting system is disclosed to provide a combination price quote about a service provider to a consumer. In this system, a database has a service provider profile managed by the service provider; a pre-formulated questionnaire saved on the database; a first labor rate assigned to the service provider profile; and a first hidden cost multiplier assigned to the service provider profile. In one example, a first user interface allows the consumer to enter a set of answers to the pre-formulated questionnaire; and logic to calculate the combination price quotes which includes a basic cost and a hidden cost. In addition, the basic cost is a function of the first labor rate, the hidden cost includes a function of the first hidden cost multiplier, and the user interface allows the consumer to see the combination price quote.

In some embodiments, a second user interface and a service provider profile, wherein the second user interface allows the service provider to enter and save at least one of the first labor rate and the first hidden cost multiplier.

In some embodiments, the second user interface allows the service provider to enter and save a second hidden cost multiplier.

In some embodiments, the questionnaire includes a question asking for a numerical perimeter, a question asking whether a first circumstantial condition is present, a question asking whether a second circumstantial condition is present, wherein the first hidden cost multiplier is assigned to the first circumstantial condition, and the second hidden cost multiplier is assigned to the second circumstantial condition. In one example, the questionnaire is supplied by the system administrator.

In some embodiments, the second user interface allows the service provider to enter and save a second labor rate and a threshold perimeter, wherein the basic cost is a function of the first labor rate when the numerical perimeter is below the threshold perimeter, and wherein the basic cost is a function of the second labor rate when the numerical perimeter is equal to or above the threshold perimeter.

Advantageously, the basic cost includes at least one of a basic cost of goods and a basic cost of labor, and the hidden cost includes at least one of a hidden cost of goods and a hidden cost of labor.

Advantageously, the first user interface displays a plurality of goods associated with the service provider's services, and the first user interface allows the consumer to select from the plurality of goods, and to receive the combination price quote relating to each selected goods.

Advantageously, a goods provider profile managed by a goods provider, and a third user interface wherein the goods provider can maintain a price list on the plurality of goods, wherein the price list is linked to and displayed on the service provider profile.

Advantageously, the system is an online platform, an online social network, software, or a mobile device application.

Advantageously, the goods providers include manufacturers of goods, distributors of goods, retailers of goods, even home-made stores.

Advantageously, the service providers include any one who provides services whether or not the service is related to particular goods.

Advantageously, the second user interface allows the service provider to set automatic price surging based on season, days of week, availability, and amount of work already committed.

Advantageously, the first user interface simultaneously displays to the consumer combination price quotes from a plurality of service providers.

Advantageously, the second user interface has an option allowing a service provider to pay a price to affect a number of results shown on the first user interface.

Advantageously, the second user interface has an option allowing the service provider to request goods from a good provider; and has an option allowing the service provider to add a premium to the goods.

Advantageously, the system calculates a difference between the combination price quote and an eventual invoice price to derive and display a percentage difference, and wherein a previous consumer review and rating accuracy data is displayed to the consumer about the service provider, the contractor, and/or the like.

Advantageously, the first user interface allows the consumer to enter the eventual price, and the system provides previous consumer review and rating accuracy data so consumer can see how accurate this service provider, this contractor, or the like has been.

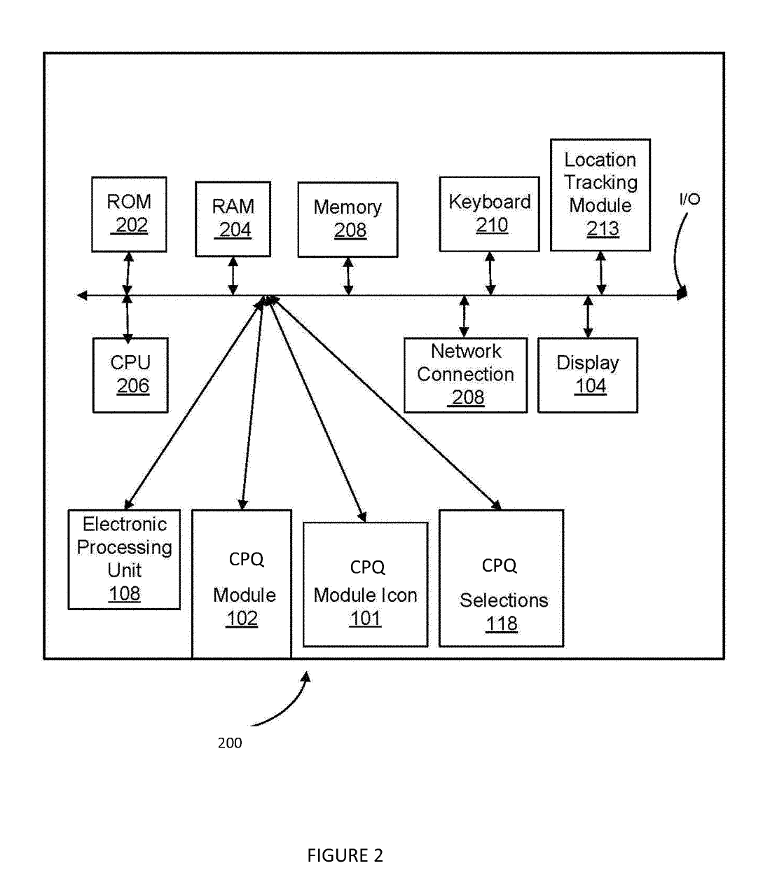

FIG. 2 illustrates a block diagram 200 of processing systems 100, 200 illustrating interaction between CPQ module icon and system 101, 100 and mobile device 106 according to an embodiment of the present disclosure of FIG. 1.

Referring now to FIG. 2, an exemplary embodiment of processing system 200. Device(s) connect(s) to network in FIG. 1 includes a processing system. Processing system 200 has a central processing unit (CPU) 206 that may be a processor, microprocessor, or any combination of processors and microprocessor that executes instructions stored in memory to perform an application. CPU 206 connects memory bus and Input/Output bus. A non-volatile memory, such as, Read Only Memory (ROM) 202 is connected to CPU 206 via memory bus 214. ROM 202 stores instructions for initialization and other systems command Volatile memory such as Random Access Memory (RAM) 204, for example, DRAM, and/or SDRAM, connects to CPU 206 via memory bus. RAM, DRAM, SDRAM or the like stores instructions for processes that are executed and data operated on by one or more executed processes. Peripheral devices include memory, display, I/O device, and network connection device connected to CPU 206 via I/O bus. I/O bus carries data between user mobile device 106, e.g., CPQ module 102, CPQ module Icon 101, electronic processing unit 108, and a CPQ selections 118, and the like, the CPU 206, Memory, e.g., read/write compact discs (CDs) and magnetic disk drives, stores data unto a media. Display 104 is a monitor and/or display and associated drivers, including electronic drivers and electronic modules, that convert data to a display. I/O device is a keyboard, a pointing device or other device that may be used by a user to input data. Network device is a modem or Ethernet that connects processing system 200 to a network.

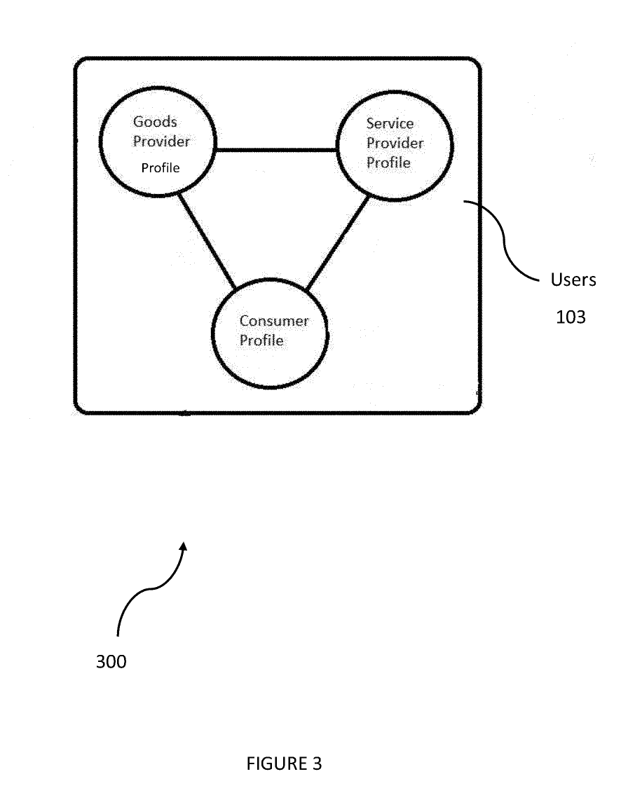

FIG. 3 is a block diagram 300 that illustrates profiles of users of the CPQ module icon and system 101, 100 downloaded on mobile device (mobile phone) 106 according to an embodiment of the present disclosure of FIG. 1.

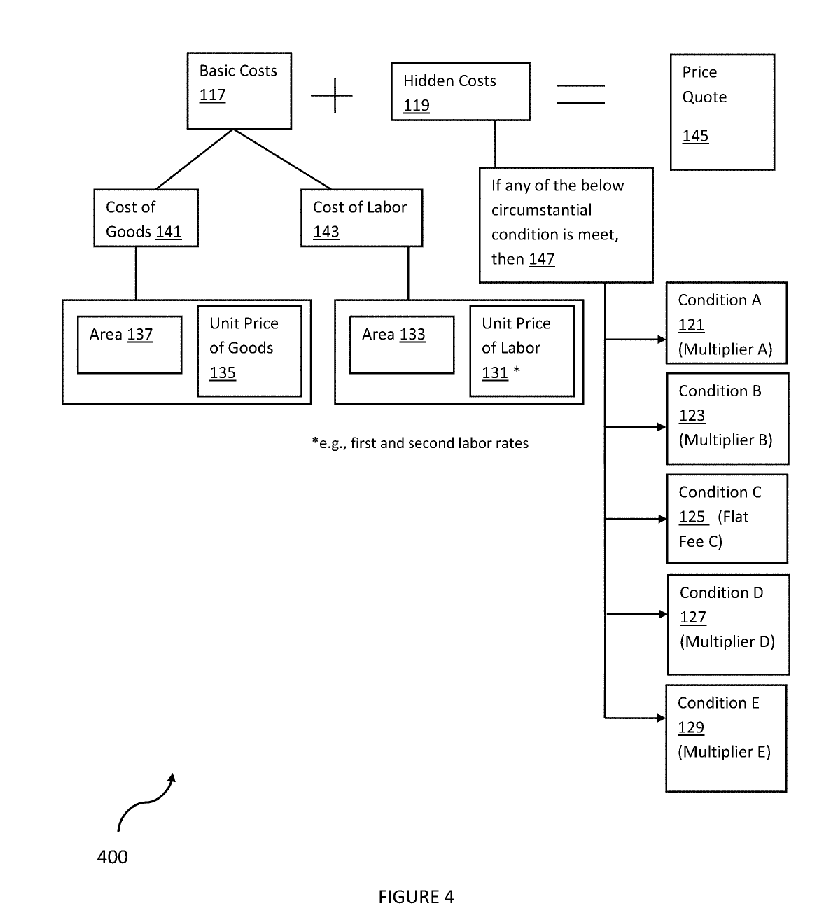

FIG. 4 is a block diagram 400 that illustrates calculations of basic costs 117, cost of goods 141, cost of labor 143, and hidden costs 119 and generates a price quote 145 of the CPQ module icon and system 101, 100 downloaded on mobile device (mobile phone) 106 according to an embodiment of the present disclosure of FIG. 1.

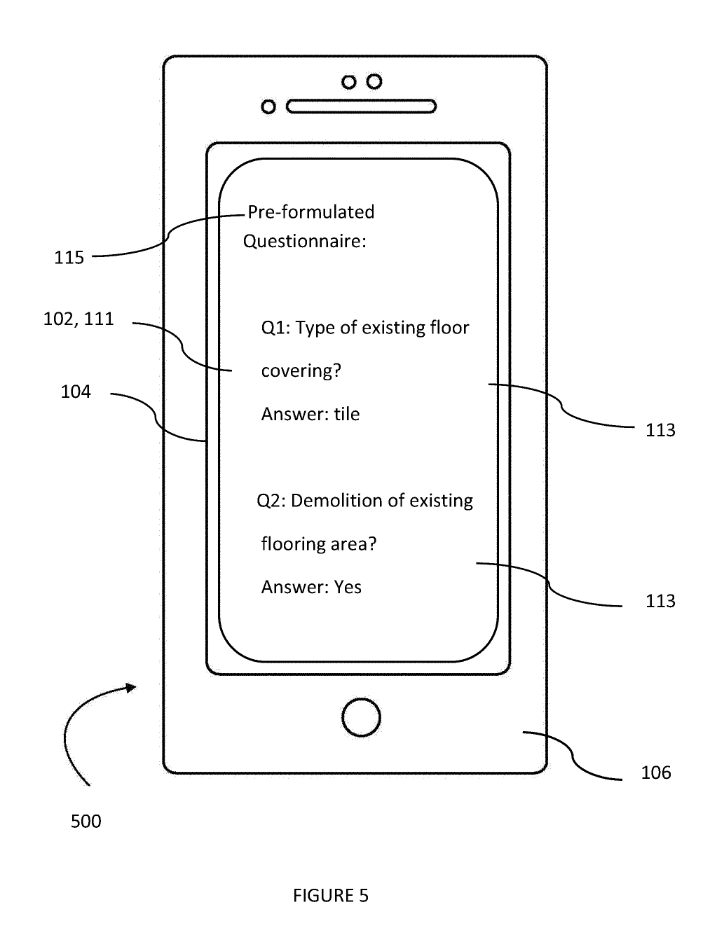

FIG. 5 is a screen shot 500 of a pre-formulated questionnaire 115 that illustrates CPQ module icon and system 101, 100 downloaded on mobile device (mobile phone) 106 according to an embodiment of the present disclosure of FIG. 1.

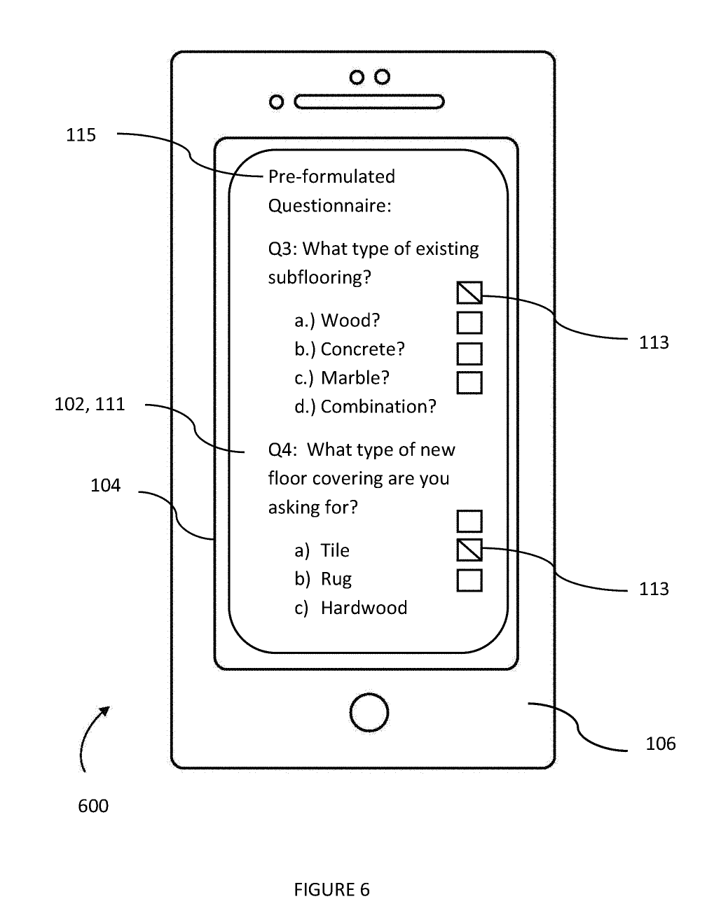

FIG. 6 is a screen shot 600 of a pre-formulated questionnaire 115 that illustrates CPQ module icon and system 101, 100 downloaded on mobile device (mobile phone) 106 according to an embodiment of the present disclosure of FIG. 1.

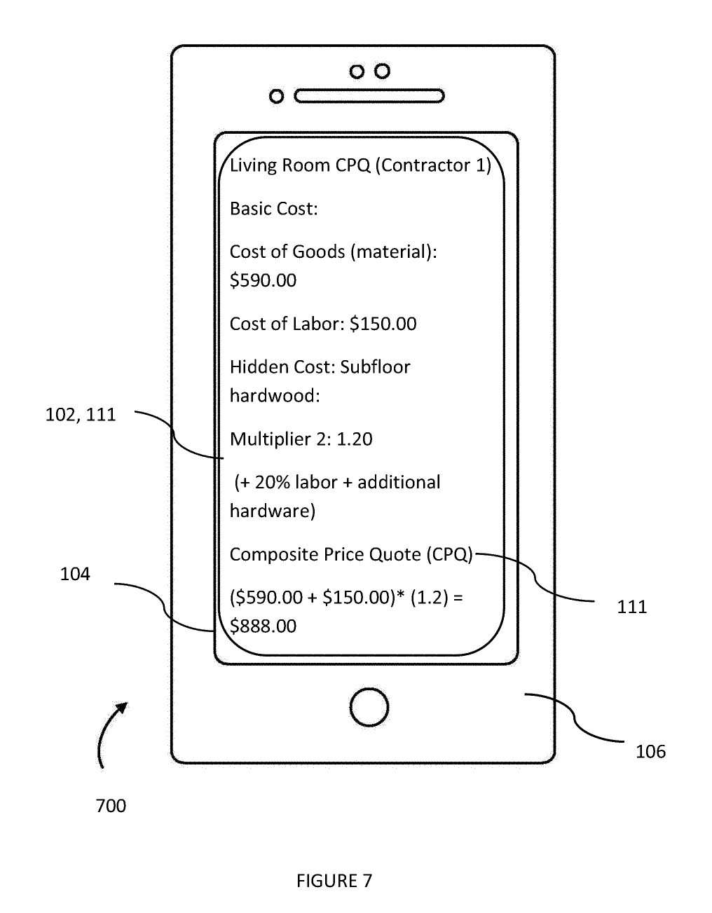

FIG. 7 is a screen shot 700 of a Composite Price Quote (CPQ) for Contractor 1 including basic cost 117 and hidden cost 119 that illustrates CPQ module icon and system 101, 100 downloaded on mobile device (mobile phone) 106 according to an embodiment of the present disclosure of FIG. 1.

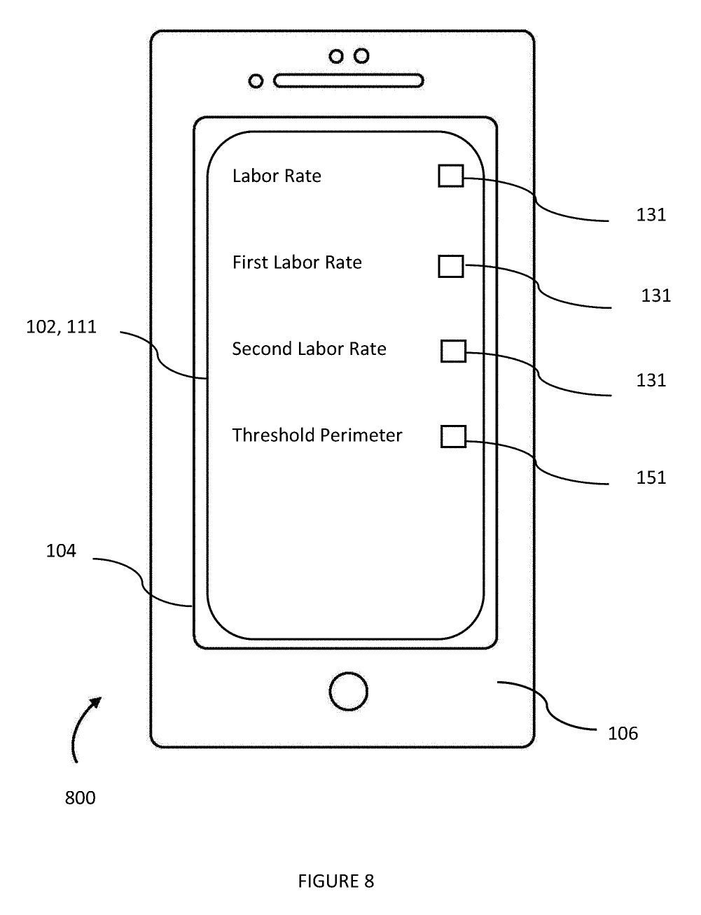

FIG. 8 is a screen shot 800 of type of labor rates and threshold perimeter 151 determining if a first labor rate or a second labor rate applies that illustrates CPQ module icon and system 101, 100 downloaded on mobile device (mobile phone) 106 according to an embodiment of the present disclosure of FIG. 1.

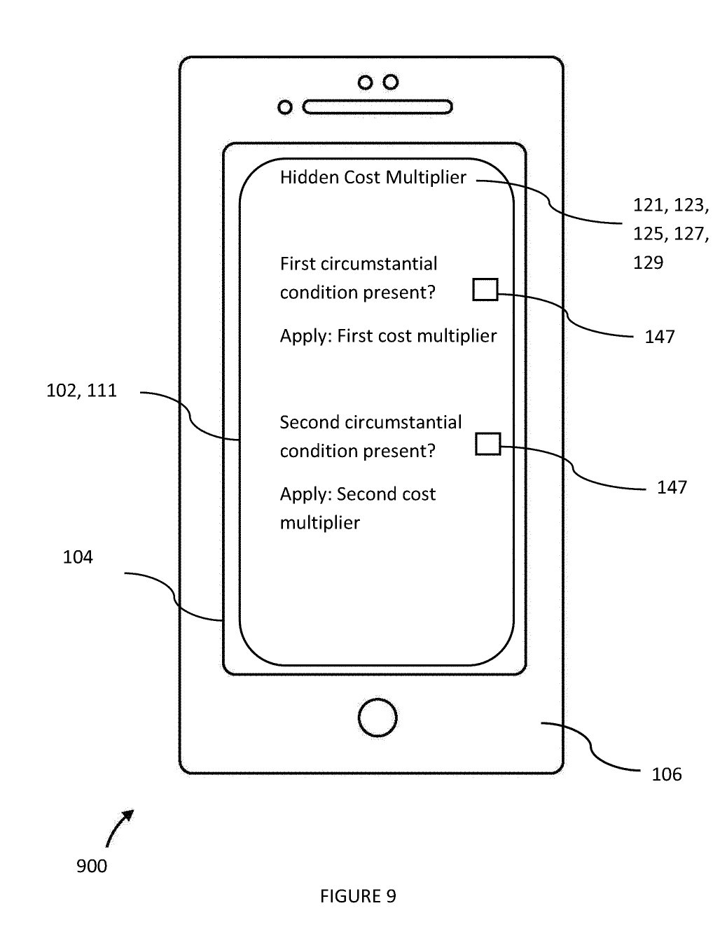

FIG. 9 is a screen shot 900 of hidden cost multipliers 121, 123, 125, 127, 129 based on first or second circumstantial condition being present that illustrates CPQ module icon and system 101, 100 downloaded on mobile device (mobile phone) 106 according to an embodiment of the present disclosure of FIG. 1.

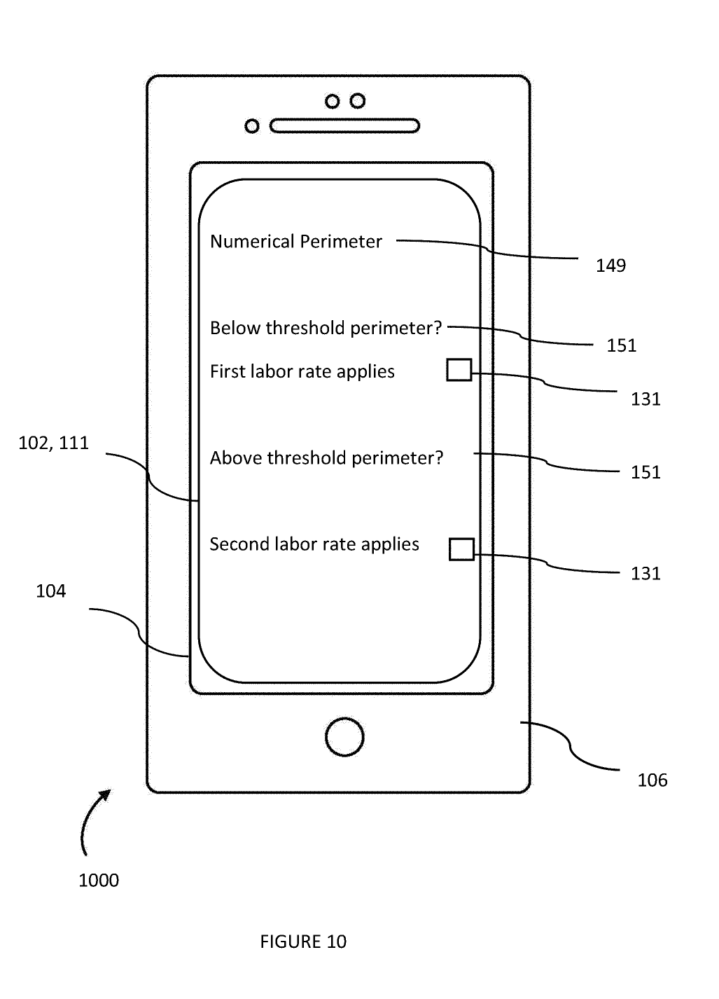

FIG. 10 is a screen shot 1000 of numerical perimeter 149 and threshold perimeter 151 that illustrates CPQ module icon and system 101, 100 downloaded on mobile device (mobile phone) 106 according to an embodiment of the present disclosure of FIG. 1.

1.

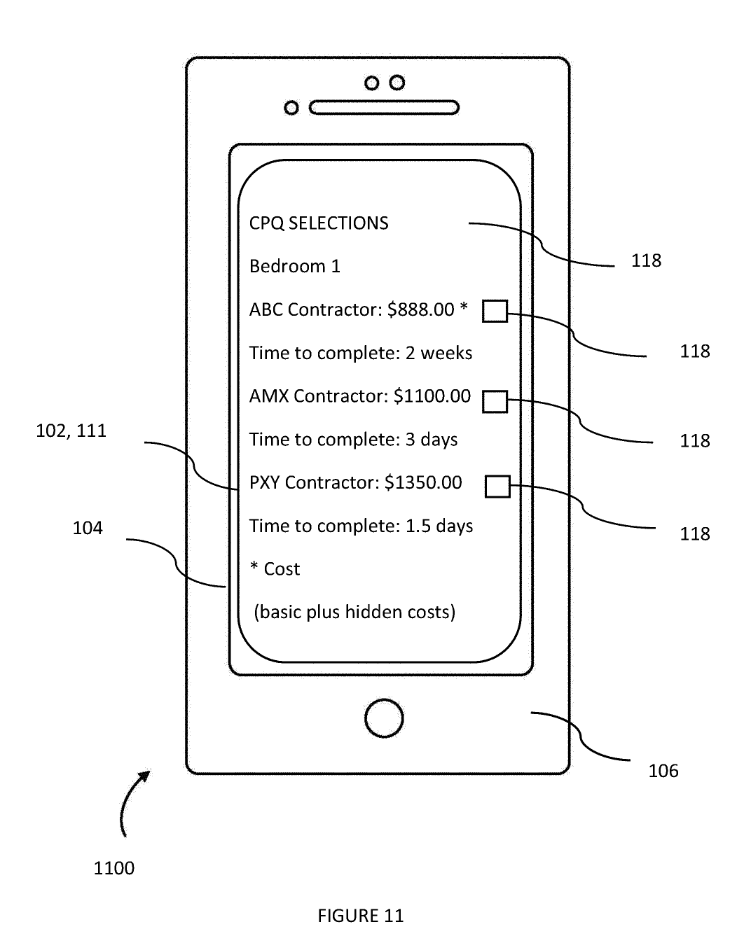

FIG. 11 is a screen shot 1100 of the CPQ selections 118 that illustrates CPQ module icon and system 101, 100 downloaded on mobile device (mobile phone) 106 according to an embodiment of the present disclosure of FIG. 1.

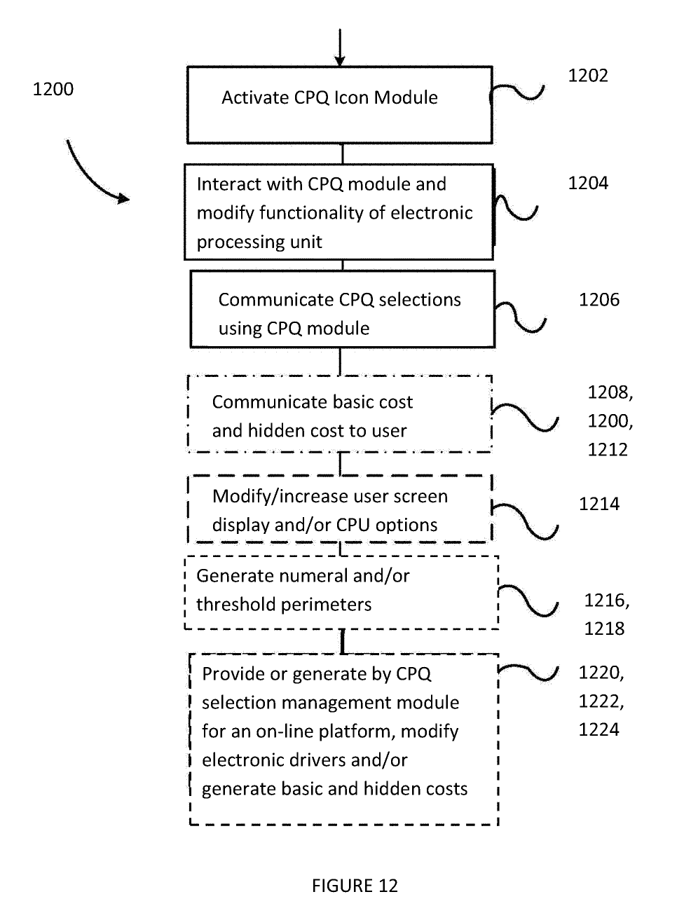

FIG. 12 is a flowchart 1200 illustrating a method of use for CPQ module icon and system 101, 100 according to an embodiment of the present disclosure of FIGS. 1-11.

Referring now to FIG. 12, a method 1200 is disclosed of improved interactive e-commerce system for a mobile phone of a user that modifies at least one of labor and materials prices through a combination price quote (CPQ) request from at least one of one or more service providers and one or more goods providers. In step 1202, activate the system by pressing a CPQ module icon 101 on the screen display 104. In step 1204, selectively interact by a CPQ module 102 with and modifying functionally of at least one electronic processing unit responsible for functionality of at least one of a screen display module, a location tracking module, and a central processing unit module 110 to select and display only a selected number of one or more combination price quote (CPQ) selections 118 on the mobile device 106 based on responses by user to a pre-formulated questionnaire. In step 1206, communicating utilizing the CPQ module 102 by pressing the CPQ module icon 101 on the screen display 104 a portion of the selected number of the one or more combination price quote (CPQ) selections 118 selected by a CPQ selection management module 111 responsive to a selection by the user. For example, the user includes a consumer, a service provider, and a goods provider.

In step 1208, communicate by the user 103 the responses including a plurality of answers to the pre-formulated questionnaire 115 regarding the CPQ request through the CPQ module 102 to the at least one of the one or more service providers and the one or more goods providers. Furthermore, in responsive to the plurality of answers, communicate by the at least one of the one or more service providers and the one or more goods providers at least one of a labor rate 131 and a hidden cost multiplier 121, 123, 125, 127, 129.

In step 1210, communicate by the user through the CPQ module 102 a plurality of answers from the user responsive to the pre-formulated questionnaire 115 and responsive to the plurality of answers 113; and calculate by the CPQ module 102 a basic cost 117 and a hidden cost 119 respectively responsive to the plurality of answers 113 and a labor rate 131 and a hidden cost multiplier 121, 123, 125, 127, 129. For example, the labor rate 131 and a hidden cost multiplier 121, 123, 125, 127, 129 are provided by the at least one of the one or more service providers and the one or more group providers responsive to the plurality of answers 113. In addition, accept by the user one of the selected number of one or more combination price quote (CPQ) selections 118.

In step 1212, communicate by the pre-formulated questionnaire 115 responses including a plurality of answers 113 thereto regarding the CPQ request from the CPQ module 102 to the at least one of the one or more service providers and the one or more group providers. In addition, calculate by the CPQ module 102 a basic cost 117 and a hidden cost 119 respectively responsive to the plurality of answers 113 and a basic labor cost 143 and a hidden cost multiplier 121, 123, 125, 127, 129 provided by the at least one of the one or more service providers and the one or more group providers responsive to the plurality of answers 113; and accepting by the user 103 one of the selected number of one or more combination price quote (CPQ) selections 118.

In step 1214, the CPQ module 102 selectively interacts with and modifies functionality of at least one electronic processing unit 108 responsible for functionality of the at least one of a screen display module, a location tracking module, and a central processing unit module 110 on the mobile device 106 includes the CPQ module 102 modifying central and auxiliary processing unit instruction sets for the CPQ selection management module 111 on the screen display 104 of the mobile device 106 responsive with the selection by the user 103.

In step 1216, communicate questions by the pre-formulated questionnaire 115 requesting a numerical perimeter 149. For example, the questions include a first question and a second question. In some embodiments, a first question of the questions asks whether a first circumstantial condition 147 is present. In some embodiments, a second question of the questions asks whether a second circumstantial condition 147 is present. For example, the hidden cost multiplier 121, 123, 125, 127, 129 includes a first cost multiplier and a second hidden cost multiplier. In another example, the first hidden cost multiplier is assigned to the first circumstantial condition 147, and a second hidden cost multiplier is assigned to the second circumstantial condition 147.

In step 1218, the labor rate 131 includes a first labor rate and a second labor rate and the at least one of the one or more service providers and the one or more goods providers enters the second labor rate and a threshold perimeter 151. For instance, the basic cost 117 is a function of the first labor rate when the numerical perimeter 149 is below the threshold perimeter 151. In another instance, the basic cost 117 is a function of the second labor rate when the numerical perimeter 149 is equal to or above the threshold perimeter 151.

In step 1220, the system 100 is an online platform, an online social network, a software, or a mobile device application; wherein the one or more goods providers include manufacturers of goods, distributors of goods, retailers of goods, even home-made stores; and wherein the one or more service providers include any one who provides services whether or not the service is related to a particular goods.

In step 1222, the CPQ selection management module 111 can be modified in accordance with instructions and electronic drivers and programming from the CPQ module 102. In some embodiments, the at least one electronic processing unit 108 includes at least one of a central processing unit, a device driver, a display driver, an electronic driver, a module or application driver, and a screen display driver. In some embodiments, the CPQ selection management module 111 includes a screen menu, the screen menu provides for the user moving one or more fingers up, down, side to side and around the screen menu to select one or more CPQ selections 118.

In step 1224, the one or more CPQ selections 118 include: a names of the at least one of the one or more service providers and the one or more goods providers, the labor rate of a selection of quotes of the one or more service providers, the hidden cost multiplier of a selection of bides of at least one of the one or more service providers and the one or more goods providers, and a possible price for the request for each of quote of at least one of the one or more service provider and the one or more goods providers can fill.

In some embodiments, the one or more CPQ selections 118 include videos or sound tracks that include advertisements and company specific information responsive to the one or more CPQ selections 118 to the user. In some embodiments, the one or more videos or sound tracks are communicated wireless 114, 116, and 120 with a satellite communication or satellite link 112 to the user on the mobile device 106. In some embodiments, the one or more CPQ selections 118 configured to provide sound tracks including itemized information pertaining to basic labor costs, hidden cost multipliers, sales information and other pertinent data relevant to the request selected for the user on the mobile device 106.

It should be noted that step(s) 1208-1224 is/are optional steps and may not be implemented in all cases. Optional steps of method 1200 are illustrated using dotted lines in FIG. 12 so as to distinguish them from the other steps of method 1200.

In another embodiment, a method is disclosed of generating value between a consumer, a service provider, and a goods provider. In this embodiment, the method includes the steps of: providing an online platform to be displayed on a mobile device, a tablet computer, or a personal computer, the platform having a first user interface and a second user interface; providing a pre-formulated questionnaire via the first user interface to the consumer regarding a project; receiving a plurality of answers from the consumer in response to the pre-formulated questionnaire; allowing the service provider to enter and save a first labor rate and a first hidden cost multiplier via the second user interface; calculating a basic cost 117 based on the first labor rate and the plurality of answers; calculating a hidden cost based on the first hidden cost multiplier and the plurality of answers; deriving and displaying a combination price quote which includes the basic cost 117 and the hidden cost 119.

In some embodiments, the service provider enters and saves a second hidden cost multiplier via the second user interface, and use the second hidden cost multiplier to calculate the hidden cost only when certain conditions are met in the plurality of answers.

In some embodiments, the method includes displaying simultaneously on the first user interface a plurality of combination price quotes showing differences in at least one of goods, the service provider, and a scheduled date of service.

In some embodiments, the method includes charging a fee from the service provider to influence what is shown on the first user interface to the consumer.

In some embodiments, the method includes linking a goods provider to the service provider on the platform, and allowing the service provider to select a plurality of goods to be displayed in association with the service provider, and allowing the service provider to add a premium to the plurality of goods.

In some embodiments, the method includes linking a goods provider to the service provider on the platform, and allowing a price of goods shown on the second user interface be changed by either the goods provider, the service provider, or both; and wherein changes in the price of goods automatically changes the combination price quote.

In some embodiments, the method includes allowing a consumer to see a previous consumer review and rating accuracy data about a service provider's, contractors', or the like combination price quote.

In some embodiments, the method includes allowing a service provider to set a threshold value for the platform to automatically change a first labor rate, wherein the threshold value is at least one selected from a group consisting of a volume of already committed projects, a date, a price, and a square footage.

It should be noted as herein described in the method, the steps and/or method of contemplated use can be carried out in many different ways, procedures, and the like according to, for example, one or more user preference(s). “[S]tep of” should not be interpreted as “step for”, in the claims herein and is not intended to invoke the provisions of 35 U.S.C. § 112, ¶6.

Upon reading this specification, it should be appreciated that, under appropriate circumstances, considering such issues as user requirements or wishes, design considerations, marketing preferences, cost(s), structural requirement(s), available materials, technological advances, etc., other methods of use arrangements such as, for example, orders within above-mentioned list that are different, eliminated and/or additional steps, including or eliminating, for example, procedure, process, and/or maintenance step(s), etc., may be sufficient.

It should be apparent, however, to those skilled in the art that many more modifications besides those already described are possible without departing from the disclosed concepts herein. The embodiment, therefore, is not to be restricted except in the spirit of the appended claims. Moreover, in interpreting both the specification and the claims, all terms should be interpreted in the broadest possible manner consistent with the context.

In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, and as described herein are expressly contemplated as being equivalent within the scope of the claims and understood by those knowledgeable in the art. Therefore, obvious substitutions now or later known to one with ordinary skill in the art are defined to be within the scope of the defined elements and the reading of the specification as described herein.

The claims are thus to be understood to include what is specifically illustrated and described above, what is conceptually equivalent, what can be obviously substituted and also what essentially incorporates the essential idea of the embodiment. In addition, where the specification and claims refer to at least one of something selected from the group consisting of A, B, C . . . and N, the text should be interpreted as requiring only one element from the group, not A plus N, or B plus N, etc

What is claimed is new and desired to be protected by Letters Patent is set forth in the appended claims:

1. An improved interactive e-commerce system for a mobile phone or a computer of a user that modifies at least one of labor and materials prices through a combination price quote (CPQ) request from at least one of one or more service providers and one or more goods providers, the system comprising:
a CPQ module icon on the screen display configured to connect to a CPQ module; the CPQ module selectively interacts with and modifies functionality of at least one electronic processing unit responsible for functionality of at least one of a screen display module, a location tracking module, and a central processing unit module to select and display only a selected number of one or more combination price quote (CPQ) selections on the mobile device based on responses by the user to a pre-formulated questionnaire; and
upon activation of the CPQ module icon, the CPQ module communicates to a portion of the selected number of the one or more combination price quote (CPQ) selections selected by a CPQ selection management module responsive to a selection by the user;
wherein the user includes a consumer, a service provider, and a goods provider.

2. The system of claim 1, wherein the responses by the user include a plurality of answers to the pre-formulated questionnaire regarding the request through the CPQ module to the at least one of the one or more service providers and the one or more goods providers; and responsive to the plurality of answers, the at least one of the one or more service providers and the one or more goods providers provide at least one of a labor rate and a hidden cost multiplier.

3. The system of claim 1, wherein the user communicates through the CPQ module a plurality of answers from the user responsive to the pre-formulated questionnaire and responsive to the plurality of answers, the CPQ module calculates a basic cost and a hidden cost respectively responsive to the plurality of answers and a labor rate and a hidden cost multiplier provided by the at least one of the one or more service providers and the one or more group providers responsive to the plurality of answers; wherein the user accepts one of the selected number of the one or more combination price quote (CPQ) selections.

4. The system of claim 1, wherein the pre-formulated questionnaire communicates the responses by the user including a plurality of answers thereto regarding the CPQ request from the CPQ module to the at least one of the one or more service providers and the one or more group providers; wherein the CPQ module calculates a basic cost and a hidden cost respectively responsive to the plurality of answers and a basic labor cost and a hidden cost multiplier provided by the at least one of the one or more service providers and the one or more group providers responsive to the plurality of answers; and wherein the user accepts one of the selected number of the one or more combination price quote (CPQ) selections.

5. The system of claim 1, wherein the CPQ module selectively interacts with and modifies functionality of at least one electronic processing unit responsible for functionality of the at least one of a screen display module, a location tracking module, and a central processing unit module on the mobile device includes the CPQ module modifying central and auxiliary processing unit instruction sets for the CPQ selection management module on the screen display of the mobile device responsive with the selection by the user.

6. The system of claim 2, wherein the pre-formulated questionnaire includes questions that ask for a numerical perimeter, a first question of the questions asks whether a first circumstantial condition is present, and a second question of the questions asks whether a second circumstantial condition is present; wherein the hidden cost multiplier includes a first cost multiplier and a second hidden cost multiplier; and wherein the first hidden cost multiplier is assigned to the first circumstantial condition, and a second hidden cost multiplier is assigned to the second circumstantial condition.

7. The system of claim 3, wherein the labor rate includes a first labor rate and a second labor rate; wherein the at least one of the one or more service providers and the one or more goods providers enters the second labor rate and a threshold perimeter, wherein the basic cost is a function of the first labor rate when the numerical perimeter is below the threshold perimeter, and wherein the basic cost is a function of the second labor rate when the numerical perimeter is equal to or above the threshold perimeter.

8. The system of claim 1, wherein the system is an online platform, an online social network, a software, or a mobile device application; wherein the one or more goods providers include manufacturers of goods, distributors of goods, retailers of goods, even home-made stores; and wherein the one or more service providers include any one who provides services whether or not the service is related to a particular goods.

9. The system of claim 1, wherein the CPQ selection management module can be modified in accordance with instructions and electronic drivers and programming from the CPQ module; wherein the at least one electronic processing unit includes at least one of a central processing unit, a device driver, a display driver, an electronic driver, a module or application driver, and a screen display driver; and wherein the CPQ selection management module includes a screen menu, the screen menu provides for the user moving one or more fingers up, down, side to side and around the screen menu to select one or more of the one or more CPQ selections.

10. The system of claim 7, wherein the one or more CPQ selections include: names of the at least one of the one or more service providers and the one or more goods providers, the labor rate of a selection of quotes of the one or more service providers, the hidden cost multiplier of a selection of bides of at least one of the one or more service providers and the one or more goods providers, and a possible price for the CPQ request for each of a quote of at least one of the one or more service provider and the one or more goods providers can fill; and the one or more CPQ selections include videos or sound tracks that include advertisements and company specific information responsive to the one or more CPQ selections to the user; wherein the one or more videos or sound tracks are communicated wireless with a satellite communication or satellite link to the user on the mobile device; and wherein the one or more CPQ selections configured to provide sound tracks including itemized information pertaining to basic labor costs, hidden cost multipliers, sales information and other pertinent data relevant to the request selected for the user on the mobile device.

11. A method of improved interactive e-commerce system for a mobile phone of a user that modifies at least one of labor and materials prices through a combination price quote (CPQ) request from at least one of one or more service providers and one or more goods providers, the system comprising:
activating a CPQ module icon on the screen display;
selectively interacting by a CPQ module with and modifying functionally of at least one electronic processing unit responsible for functionality of at least one of a screen display module, a location tracking module, and a central processing unit module to select and display only a selected number of one or more combination price quote (CPQ) selections on the mobile device based on responses by user to a pre-formulated questionnaire; and
communicating utilizing the CPQ module by pressing the CPQ module icon on the screen display a portion of the selected number of the one or more combination price quote selections selected by a CPQ selection management module responsive to a selection by the user; wherein the user includes a consumer, a service provider, and a goods provider.

12. The method of claim 11, comprising communicating by the user the responses including a plurality of answers to the pre-formulated questionnaire regarding the CPQ request through the CPQ module to the at least one of the one or more service providers and the one or more goods providers; and responsive to the plurality of answers, communicating by the at least one of the one or more service providers and the one or more goods providers at least one of a labor rate and a hidden cost multiplier.
The method of claim 11, comprising:
communicating by the user through the CPQ module a plurality of answers from the user responsive to the pre-formulated questionnaire and responsive to the plurality of answers;
calculating by the CPQ module a basic cost and a hidden cost respectively responsive to the plurality of answers and a labor rate and a hidden cost multiplier provided by the at least one of the one or more service providers and the one or more group providers responsive to the plurality of answers; and
accepting by the user accepts one of the selected number of the one or more combination price quote (CPQ) selections.

13. The method of claim 11, comprising:
communicating by the pre-formulated questionnaire responses including a plurality of answers thereto regarding the CPQ request from the CPQ module to the at least one of the one or more service providers and the one or more group providers; and
calculating by the CPQ module a basic cost and a hidden cost respectively responsive to the plurality of answers and a basic labor cost and a hidden cost multiplier provided by the at least one of the one or more service providers and the one or more group providers responsive to the plurality of answers; and accepting by the user one of the selected number of the one or more combination price quote (CPQ) selections.

14. The method of claim 11, wherein the CPQ module selectively interacts with and modifies functionality of at least one electronic processing unit responsible for functionality of the at least one of a screen display module, a location tracking module, and a central processing unit module on the mobile device includes the CPQ module modifying central and auxiliary processing unit instruction sets for the CPQ selection management module on the screen display of the mobile device responsive with the selection by the user.

15. The method of claim 12, comprising:
communicating questions by the pre-formulated questionnaire requesting a numerical perimeter including: a first question of the questions asks whether a first circumstantial condition is present, and a second question of the questions asks whether a second circumstantial condition is present;
wherein the hidden cost multiplier includes a first cost multiplier and a second hidden cost multiplier; and
wherein the first hidden cost multiplier is assigned to the first circumstantial condition, and a second hidden cost multiplier is assigned to the second circumstantial condition.

16. The method of claim 13,
wherein the labor rate includes a first labor rate and a second labor rate; wherein the at least one of the one or more service providers and the one or more goods providers enters the second labor rate and a threshold perimeter, and
wherein the basic cost is a function of the first labor rate when the numerical perimeter is below the threshold perimeter, and wherein the basic cost is a function of the second labor rate when the numerical perimeter is equal to or above the threshold perimeter.

17. The method of claim 11,
wherein the system is an online platform, an online social network, a software, or a mobile device application; wherein the one or more goods providers include manufacturers of goods, distributors of goods, retailers of goods, even home-made stores; and
wherein the one or more service providers include any one who provides services whether or not the service is related to a particular goods.

18. The method of claim 11,
wherein the CPQ selection management module can be modified in accordance with instructions and electronic drivers and programming from the CPQ module;
wherein the at least one electronic processing unit includes at least one of a central processing unit, a device driver, a display driver, an electronic driver, a module or application driver, and a screen display driver; and
wherein the CPQ selection management module includes a screen menu, the screen menu provides for the user moving one or more fingers up, down, side to side and around the screen menu to select the one or more CPQ selections.

19. The method of claim 17,
wherein the one or more CPQ selections include: names of the at least one of the one or more service providers and the one or more goods providers, the labor rate of a selection of quotes of the one or more service providers, the hidden cost multiplier of a selection of bides of at least one of the one or more service providers and the one or more goods providers, and a possible price for the request each for quote of at least one of the one or more service provider and the one or more goods providers can fill; and the one or more CPQ selections include videos or sound tracks that include advertisements and company specific information responsive to the one or more CPQ selections to the user;
wherein the one or more videos or sound tracks are communicated wireless with a satellite communication or satellite link to the user on the mobile device; and wherein the one or more CPQ selections configured to provide sound tracks including itemized information pertaining to basic labor costs, hidden cost multipliers, sales information and other pertinent data relevant to the request selected for the user on the mobile device.
